(19) United States
(12) Patent Application Publication
(10) Pub. No.: US 2026/0152118 A1
(43) Pub. Date: Jun. 4, 2026

(54) VEHICLE WINDOW HAVING A LIGHT SOURCE AND A LIGHT-CONDUCTING LAYER

(71) Applicant: Webasto SE, Stockdorf (DE)

(72) Inventors: Matthias Baumann, Stockdorf (DE); Robert Pasquarelli, Stockdorf (DE); Domenic Duersch, Stockdorf (DE); Tom Wieczorek, Stockdorf (DE)

(21) Appl. No.: 19/123,517

(22) PCT Filed: Oct. 18, 2023
(86) PCT No.: PCT/EP2023/078990

§ 371 Date: Apr. 23, 2025

(30) Foreign Application Priority Data
Oct. 24, 2022 (DE) 10 2022 128 005.5

(51) Int. Cl. B60Q 3/208; B32B 17/10; B60Q 3/62; B60Q 3/74; F21V 8/00

(52) U.S. Cl. CPC B60Q 3/208; B32B 17/10036; B32B 17/10293; B32B 17/1044; B32B 17/10541; B60Q 3/62; G02B 6/0023; G02B 6/0025; G02B 6/0031; G02B 6/0073; G02B 6/0095; B32B 2307/41; B32B 2307/412; B32B 2307/416; B32B 2307/418; B32B 2605/00; B60Q 3/74

(57) ABSTRACT

A method for manufacturing a conductive via-containing glass substrate includes: a step a of preparing a glass substrate provided with a hole and providing a metal paste part containing metal particles and a volatile solvent to fill the inside of the hole and cover at least a surface surrounding the hole of the glass substrate; a step b of heating the metal paste part to remove a part of the volatile solvent; a step c of removing a part of the metal paste part after heating to expose the surface to form a conductive via precursor in the hole, the conductive via precursor containing the metal particles and a residue of the volatile solvent and having a planarized exposed surface; and a step d of firing the conductive via precursor.

The invention relates to a vehicle window having the features of the preamble of patent claim 1.

A vehicle window of this type is known from the prior art and is usable in particular in the region of a vehicle roof. The vehicle window here can form a fixed roof element or else a cover element of a roof opening system, by means of which a roof opening can be optionally closed or freed. The known vehicle window comprises a window body, which can be of curved design and is provided with a light guide layer. The light guide layer fulfills in particular esthetic aspects within the vehicle and at the same time provides for vehicle interior lighting. Furthermore, the known vehicle window is provided with a light source, the light from which is able to be incoupled into the light guide layer. The incoupling usually takes place via a margin or an (window) edge of the light guide layer. The light guide layer can form the viewable surface of the vehicle window that is visible from the vehicle interior, such that when the light source is activated, the light guide layer realizes a luminous element of the vehicle window which, if appropriate, enables a vehicle interior to be illuminated. In the case of the known vehicle window, the light guide layer has smaller dimensions than the window body, on the inner side of which the light guide layer is arranged, in order that light emitted by the light source is able to be incoupled via the margin of the light guide layer. This kind of incoupling is costly, however, and either requires a window of small dimensions or necessitates mounting of the light source in a wet region of the vehicle.

The prior art likewise discloses incoupling light from a light source into the light guide layer using a prism or some other optical element. The use of a prism or an optical element enables a freer choice in the positioning of the light source, since the latter then no longer needs to be arranged directly in the marginal region of the light guide layer. This design freedom has the advantage that as a result, in contrast to the arrangement directly in the edge region of the light guide layer, the light source is no longer arranged in the wet region, but rather can also be provided in a dry region protected against moisture. This makes it possible to dispense with seals and/or protection against wetness. By way of example, the use of a prism applied on an inner side of an inner light guide layer, for example, makes it possible to arrange a light source laterally below the edge region of the light guide layer, in particular offset with respect to the edge region.

What is disadvantageous about the incoupling of light using a prism or some other optical element, depending on the application situation, is that additional component parts are required and an installation space requirement possibly increases compared with lateral light incoupling. In addition, this technical approach has relatively high demands on tolerances between the prism and the light source, since a light incoupling efficiency is dependent on the relative positioning and/or pose of the light source with respect to the prism.

On the basis of the statements above, an object of the invention can be considered that of further developing a vehicle window designed according to the generic type mentioned in the introduction in such a way that light incoupling into a light guide layer and/or a light distribution within the light guide layer can be improved and/or optical light losses can be reduced.

This object is achieved according to the invention by the vehicle window having the features of patent claim 1.

The dependent claims relate to advantageous embodiments of the invention. All combinations of at least two features disclosed in the description, the claims and/or the figures fall within the scope of the invention. It is understood that the explanations given with respect to the vehicle window equivalently relate to the vehicle according to the invention, without being redundantly mentioned for this vehicle. It is understood here in particular that idiomatic transformations and/or analogous substitution of respective terms in the context of customary linguistic practice, in particular the use of synonyms supported by the generally recognized linguistic literature, are encompassed by the present disclosure content, without being explicitly mentioned in their respective formulation.

According to the invention, a vehicle window is proposed, comprising a window body arrangement. The window body arrangement comprises a light guide layer, a window outer body, which has an outer side facing vehicle surroundings, and a window inner body, which has an inner side facing a vehicle interior. The vehicle window furthermore comprises at least one light source, the light from which is able to be incoupled or is incoupled into the light guide layer when electromagnetic beams are emitted by the light source. The window outer body is linked to the window inner body by at least one connecting layer. The window inner body forms the light guide layer, for example. The connecting layer preferably at least regionally comprises a diffuser layer. The vehicle window is preferably a laminated glass window and/or laminated safety glass (LSG).

The window inner body, which can have the same dimensions as the window outer body or else can be made smaller than the latter, is manufactured in principle from any desired material that can be utilized as a light guide. By way of example, the window inner body is manufactured from a material comprising glass and/or polycarbonate and/or some other plastic. In the case of a window body arrangement in the form of laminated safety glass, a connecting layer between the individual window bodies is preferably formed from a material comprising PVB, EVA and/or TPU. The connecting layer can be clear or transparent or else colored.

Preferably, the connecting layer is composed of a more particularly transparent polyvinyl butyral (PVB) film. The diffuser layer can be arranged for example on or within the connecting layer. The diffuser layer can also regionally supplement and/or replace the connecting layer. The at least one connecting layer is thus for example not arranged over the whole area between the window outer body and the window inner body in order to connect these to one another, but rather can for example be supplemented and/or replaced and/or extended by the diffuser layer partially and/or in portions. Alternatively or supplementarily, the diffuser layer can be arranged and/or adhesively bonded for example on the window outer body, in particular on a side situated opposite the outer side, and/or on the window inner body, in particular on a side situated opposite the inner side. Alternatively or supplementarily, the diffuser layer can be introduced and/or embedded at least in portions and/or regionally between at least two layers of the at least one connecting layer. The connecting layer is preferably a more particularly transparent hot melt adhesive film, particularly preferably a transparent PVB hot melt adhesive film, which is already used in existing vehicle windows. Particularly in the case of laminated safety glass, the window body arrangement comprises the window outer body and the window inner body linked to the window outer body via a connecting layer. Preferably, the window inner body forms the light guide layer. Alternatively, an additional light guide layer can be applied to the window inner body, the light from the at least one light source being able to be incoupled into said layer directly or indirectly.

The solution according to the invention affords the advantage that by using or by introducing or by providing the diffuser layer, it is possible to incouple light preferably substantially perpendicularly into the light guide layer, particularly preferably by way of an arrangement of the light source in a marginal region of the inner side. This means that attachment light sources can be used, which do not need complex mounting. The use of top LEDs is possible, for example. Unlike in the prior art, an adhesive bonding process such as is necessary for the arrangement of a prism on the inner side of the window is therefore not absolutely required. However, such an option for mounting a prism still remains in the case according to the invention, too, and can still be advantageous in various design concepts. By providing the diffuser layer, it is possible to simplify and/or improve the light incoupling into the light guide layer since a higher degree of freedom of design for mounting light sources is made possible. Likewise, the diffuser layer makes it possible to improve a light distribution within the light guide layer by comparison with the prior art. A further advantage is that the diffusely incoupled light causes in particular random scattering, such that in contrast to use of a prism for light incoupling into the light guide layer, there is no need to comply with large tolerance and/or positioning requirements. In this way, the invention achieves color intermixing of the RGB colors of the light source(s) that is as uniform as possible, without the need for area for correct color rendering, for example for mounting further optical units. Moreover, the at least one light source can be positioned more freely in comparison with the prior art. The number of light sources used thus essentially only determines the brightness in the light guide layer, but not primarily the color mixing. If a plurality of light sources are used, it is thus possible to reduce the number of light sources required per unit length and/or to set a desired brightness by way of the selection of the number of light sources per unit length along the marginal region. The at least one light source can be chosen freely according to the invention, such that for example standard strips or commercially available LED strips can be selected. This enables the component costs to be reduced. It goes without saying that specific LED strips with a particular color and/or brightness profile can also be used, without adaptations being necessary with regard to trueness of color and light incoupling.

On account of the almost perpendicular incoupling of light from the light source into the light guide, preferably of light at an angle of between 60° and 120°, in particular between 70° and 110°, with respect to the inner side of the light guide layer, according to the invention it is no longer absolutely necessary to remove a coating on the inner side of the light guide in order to prevent a reflection, reduction of the brightness and/or intensity and/or spectral splitting of the light from the light source by the coating. It goes without saying that the step of removing, e.g. decoating, is optionally still possible, however.

The diffuser layer is preferably configured to redirect light penetrating through the window inner body from the light source and/or to scatter said light within the diffuser layer. The light scattering enables the light to be incoupled perpendicularly to a surface of the light guide layer, in particular to the inner side, as viewed in a main emission direction of the light source. The entering light beams are then redirected and/or deflected by the diffuser layer, such that they can propagate within the light guide layer despite the perpendicular incoupling. The diffuser layer preferably acts as an opaque (white or color) layer. By comparison with a conventional connecting layer, the diffusion properties of the diffuser layer can preferably be manipulated and/or defined by the introduction of an additive during the production of the diffuser layer. Addition of the additive can be varied depending on the desired diffusivity. Purely by way of example, white PVB material and/or diffuse PVB material, e.g. comprising white pigment particles, can be chosen as additive. In order to manipulate the diffusivity, for example, an at least regionally structured layer can be produced, enabling in particular targeted redirection of light.

The diffuser layer, in particular a diffuser film, can be produced by means of embossing, for example. The diffuser layer or the diffuser film can be in the form of a scattering film and/or in the form of a scattering element and/or in the form of a diffuser element. The diffuser layer can have a carrier film, e.g. composed of PET, which can be coated with a UV-curable resin. Such a resin can have a corresponding scattering structure, for example. A scattering structure of this type has for example a surface structure having a light scattering mode of action. A surface structure of this type can have a specific optical pattern or can be formed with such a pattern. The preferred surface structure can be produced as follows. By way of example, the preferred surface structure can be produced by nanoimprinting. In this case, preferably, a UV-curable resin is applied to the surface of a carrier film, e.g. PET. Furthermore, a so-called master mold having an engraved microstructure is used to emboss an opposite specific optical pattern into the resin. In this case, the resin is preferably simultaneously cured using UV light. The surface structure preferably forms as a layer on the surface of the carrier film. The resins used for producing the preferred surface structure can be transparent, thus giving rise to a light refracting optical unit. The preferred surface structure can be coated with metals in order thus to produce preferably structured reflectors.

A further example of a simplified structured diffuser layer is a carrier film, e.g. PET, which is provided with a metal coating, e.g. aluminum. The microstructure is preferably embossed into the film by means of pressure and/or heat in order to produce the final structure. Unlike in the case of nanoimprinting, this alternative method does not allow production of very small structures or forms having sharp edges or high aspect ratios. The method may nevertheless be preferred since it is simpler and more cost-effective than nanoimprinting.

In one preferred embodiment, the diffuser layer is provided at least in a marginal region and/or an edge region of the vehicle window. In other words, preferably, the existing, in particular transparent, connecting layer in the edge region serving as light incoupling region is replaced and/or supplemented by the diffuser layer having very great scattering or scattering in all spatial directions. The scattering can preferably be specified and/or determined by the specification of reflection and/or transmission values in a specific wavelength range and/or with a haze value. The scattering preferably causes a light color within the white color spectrum. Particularly preferably, the diffuser layer in this region replaces or supplements a more particularly conventionally used PVB film that is preferably employed as a connecting layer. According to the invention, light incoupling preferably takes place in the marginal region and/or the edge region. Consequently, the at least one light source is preferably likewise provided in the marginal region and/or the edge region. Particularly preferably, the at least one light source comprises at least one light strip having a multiplicity of light sources, particularly preferably having a multiplicity of LEDs.

In one preferred embodiment, the diffuser layer is formed by a hot melt adhesive film and/or by a printed layer and/or by a structured film and/or comprises a hot melt adhesive layer and/or a diffuser film. The diffusivity of the hot melt adhesive layer and/or of the diffuser layer is preferably significantly increased compared with a diffusivity of a conventional connecting layer, on the part of the material and/or by addition of one or more additives. The printed layer can comprise a white print and/or a (white) varnish, which is preferably applied to an outer side of the window inner body. The structured film preferably comprises a light incidence reflection of at least 42°. By way of example, a film comprising a carrier substrate, e.g. polymer substrate, having a structured surface can be used as a structured film. The structured surface has for example a multiplicity of pyramidal elevations having an inclination of the side surfaces of for example at least 30°, in particular at least 60°, and a height of up to 300 μm. In further examples, at least one pyramidal elevation can also have an inclination of the side surfaces of more than 75°, in particular more than 80°, and a height of at least 150 μm. As an alternative and/or in addition to the pyramidal elevations, it is possible to form prismatic and/or lenslike structures, such as Fresnel lenses, on the surface of the structured film. Films of this type are also referred to as “daylight redirecting films”. The carrier substrate can have an adhesive layer on the surface situated opposite the structured surface.

In one preferred embodiment, the diffuser layer comprises a diffusivity and/or a reflectivity of at least 90% and/or a light transmission in the visible spectrum of at most 1%. A standard PVB layer has for example a transmission of >70% in conjunction with a haze value of <5%.

In one preferred embodiment, the light source is arranged directly or indirectly on the inner side of the window inner body. This preferably makes it possible to enable light incoupling into the light guide layer without light deflection by means of a prism, since the light incoupled via the inner side is redirected by the diffuser layer according to the invention. As a result, even in the case of light incoupling that takes place perpendicularly to the inner side, areal and/or uniform light propagation within the light guide layer can still be achieved. It is understood that the at particularly preferably to be as large as possible. The light emission takes place proceeding from the light source in a light cone, the axis of symmetry of which corresponds to a main emission direction of the at least one light source. According to the invention, this main emission direction and/or the axis of symmetry thus preferably extend(s) perpendicularly to the inner side, in particular to the marginal and/or edge region of the inner side. In other words, in one preferred embodiment, it is possible that the light source, relative to the main emission direction of the light source, is arranged on the inner side of the window inner body in such a way that light generable by the light source is able to be incoupled substantially perpendicularly into the light guide layer.

In one preferred embodiment, a light outcoupling layer, in particular having at least one light outcoupling structure, is arranged and/or provided on a side situated opposite the inner side of the window inner body and/or between the connecting layer and the window inner body. By way of example, the light outcoupling layer can be blackened at least regionally or in patterns and can be transmissive at least regionally, such that the light guided within the light guide layer can be outcoupled or can emerge from the light guide layer only at predetermined places. The light outcoupling layer can comprise a multiplicity of frits, for example, which can be applied by printing and/or vapor deposition, for example. Alternatively or supplementarily to frits, it is also possible to apply ink and/or varnish, for example comprising scattering particles, to a side situated opposite the inner side of the window inner body and/or between the connecting layer and the window inner body. Individual patterning is made possible as a result. The light outcoupling layer can comprise a print applied to the light guide layer and/or a prism structure and/or a point structure and/or a coextruded scattering material, which are/is arranged on or integrated in the light guide layer.

In one preferred embodiment, the window body arrangement furthermore comprises a light refraction layer, which is provided preferably between the window outer body and the window inner body, particularly preferably between the diffuser layer and the window inner body. The light refraction layer is preferably arranged and/or provided outside the diffuser layer and/or adjacent to the diffuser layer. In an alternative embodiment, the light refraction layer is between window outer body and diffuser layer and/or between window outer body and light outcoupling structure. The light refraction layer preferably comprises a refractive index of at most 1.45. The diffuser layer provided according to the invention affords a variety of advantages, but in some cases may not generate sufficient brightness within the light guide layer and in particular for the outcoupled light. In order to avoid this problem, the number of light sources used can be increased. However, this may lead to additional cost expenditure. As an alternative, the inventors have now recognized that providing a light refraction layer can solve this problem. Therefore, according to the invention, in order to significantly increase the illumination efficiency of a vehicle window comprising a diffuser layer, provision is preferably made for the connecting layer to furthermore comprise the light refraction layer, i.e. a layer having a low refractive index. The light refraction layer can preferably be concomitantly laminated into the connecting layer and/or accommodated therein like a sandwich. The preferred combination of light refraction layer and diffuser layer and/or of light refraction layer and the at least one connecting layer makes it possible to increase the luminance within the light guide layer and preferably at the same time to reduce light losses. This additional measure makes it possible to significantly increase a performance, in particular a lighting performance of the vehicle window by comparison with the prior art. Alternatively or supplementarily, this additional measure, i.e. providing the light refraction layer, makes it possible to significantly reduce a number of the light sources compared with the prior art and/or compared with a construction without a light refraction layer, without needing to accept losses in respect of illuminance and/or luminance. Particularly preferably, the light refraction layer is arranged between the side of the window outer body situated opposite the outer side and the diffuser layer. Particularly preferably, the light refraction layer is in this case arranged in a tinted region of the window outer body. The light refraction layer can be provided as a film and/or as a coating on a film. Alternatively or supplementarily, the light refraction layer can be arranged directly within the diffuser layer and/or within the at least one connecting layer. In other words, the light refraction layer can be encompassed by the diffuser layer and/or by the at least one connecting layer.

In one preferred embodiment, the vehicle window comprises a light shielding element arranged directly or indirectly in a region of the light source in particular on the inner side of the window inner body. In this way, stray light which is possibly generated by the light source but is not incoupled into the light guide layer can be prevented from influencing and/or disturbing a predetermined light emission or light outcoupling from the light guide layer in particular in an optically negative manner.

In one preferred embodiment, an incoupling element is arranged on the inner side of the window body arrangement, and incouples light emitted by the light source into the light guide layer. Particularly preferably, the incoupling element is secured to the side of the window inner body facing away from the window outer body, in particular is adhesively bonded to the window inner body.

In one preferred embodiment, the incoupling element is a material body which is transparent to the light from the light source. In this case, the incoupling element can be of barlike design and/or can have a wedge-shaped or trapezoidal cross-section. In one configuration, the incoupling element has a concave curvature on the surface assigned to the light source. Consequently, light from the light source which is not directed perpendicularly to the diffuser layer can be incoupled into the incoupling element and can be incoupled into the light guide layer by the incoupling element. The incoupling element is preferably arranged near the margin of the inner side of the window body arrangement. Over the extent of the incoupling element of barlike design, light can then be incoupled into the light guide layer of the window body arrangement. The incoupling element can be designed as an optical prism, for example. The incoupling element is preferably manufactured from a material comprising PMMA (polymethyl methacrylate), PC (polycarbonate), PA (polyamide), COC (cycloolefin copolymer) or COP (cycloolefin polymer). A refractive index of the incoupling element is matched in particular to the refractive index of the adjacent light guide layer and preferably has a value of between 1.40 and 1.65 and in particular between 1.48 and 1.59. The incoupling element is preferably produced in accordance with an extrusion method or an injection molding method. Alternatively or supplementarily, the incoupling element can be formed from resin and/or from transparent polyurethane and can preferably be arranged on the window body arrangement. In order to improve internal reflection, the incoupling element can be provided with a reflective coating, which can comprise metals such as aluminum or silver and can be applied in accordance with a vapor deposition or sputtering process. In order to further improve the incoupling behavior of the light into the light guide layer, in one advantageous embodiment of the vehicle window according to the invention, an additional deflection structure is arranged between the incoupling element and the window body arrangement. By virtue of the additional deflection structure, the angle of incidence of the light on the light guide layer can be altered by corresponding refraction in order to increase the internal reflection in the light guide layer. The additional deflection structure can comprise a series of asymmetric prisms which have dimensions in the millimeters range or in the micrometers range and are arranged as a three-dimensional array or in a linear manner, as is the case for a Fresnel lens array, for example. The additional deflection structure can be formed in an integral manner with the incoupling element and can be formed directly during the manufacture thereof, for example during an extrusion process or an injection molding process. It is also conceivable for the additional deflection structure to constitute a coating of the incoupling element, for example in the form of a separate structured film.

In one preferred embodiment, the incoupling element is adhesively bonded to the window body, in particular to the inner side, by way of an adhesive layer. The adhesive layer, which preferably has a refractive index of between 1.40 and 1.65 and in particular between 1.48 and 1.56, can be formed from any optically suitable adhesive. By way of example, the adhesive layer is formed from a pressure sensitive adhesive, a liquid optically clear adhesive (LOCA), EVA (ethylene vinyl acetate), PVB (polyvinyl butyral), TPU (thermoplastic polyurethane), an epoxy adhesive or an acrylate adhesive. The materials chosen preferably have refractive indices which minimize refraction of the light beams at the interfaces and optimize the incoupling efficiency under the ideal angle conditions.

The refractive index of a window inner body manufactured from glass is in particular 1.52, whereas the refractive indices of the preferred incoupling element and of the preferred adhesive used to link the incoupling element to the window inner body can vary depending on the material chosen. If PMMA is used for the incoupling element, the refractive index is 1.49. The adhesive then has a refractive index of 1.52, for example. If an incoupling element composed of polycarbonate is used, the refractive index is 1.58, for example, whereas the refractive index of the adhesive used is 1.56. If the incoupling element is manufactured from COP, the refractive index thereof is 1.52. Preferably, the adhesive used to link the incoupling element to the glass inner body then likewise has a value of 1.52.

In one preferred embodiment, the light source is arranged on a side surface of the incoupling element. As a result, depending on design preference in the design of the vehicle window, a pose and/or positioning of the light source can be chosen in particular independently of installation space.

In one preferred embodiment, the light source is an LED bar. The at least one light source preferably comprises a high-power LED module and/or an LED bar having a multiplicity of LEDs and/or an LED strip having a multiplicity of LEDs.

In one preferred embodiment, the vehicle window comprises a reflector in a region of the light source, said reflector being aligned in a light-reflecting manner with respect to the light source and being configured to reflect light into the light guide layer. The reflector comprises aluminum, for example, which is preferably applied as adhesive tape. The reflector is arranged preferably between the window inner body and the light source and particularly preferably on the inner side of the window arrangement. The reflector preferably comprises at least one entrance opening for light. The at least one entrance opening is preferably dimensioned as a function of a dimensioning and/or an emission angle of the at least one light source. The at least one entrance opening is preferably designed to allow penetration of the light from the at least one light source. The remaining, reflective surface of the reflector is preferably configured to reflect back the light that is not internally reflected in the light guide layer, such that it is repeatedly scattered within the light guide layer. A proportion of light which remains within the light guide layer can be increased as a result.

In one embodiment, a reflector layer is arranged on the side of the light guide layer assigned to the interior of the vehicle and situated opposite the diffuser layer. The reflector layer is preferably arranged on the surface of the light guide layer assigned to the interior. In one embodiment, the reflector layer is arranged on the inner side of the window inner body. In one embodiment, the reflector layer is arranged between the light guide layer and the window inner body. The reflector layer is arranged and configured such that light which is reflected and scattered by the diffuser layer to the reflector layer is reflected into the light guide layer by the reflector layer. Consequently, light which can emerge again at that surface of the light guide layer and/or of the window inner body which faces the inner side is reflected back into the light guide layer again. Consequently, a higher proportion of the light emitted by the light source can be incoupled into the light guide layer or be relayed there and thus increase the luminance in the light guide layer.

The reflector layer can be arranged by means of adhesive bonding, varnishing, coating. The reflector layer can have light reflecting and/or light scattering properties. Preferably, a large proportion of the light reflected and/or scattered by the reflector layer is reflected to the diffuser layer, where a large proportion of this light is backscattered into the light guide layer by means of scattering action such that the light experiences a change in angle and is guided into the light guide layer, i.e. the changed angle is sufficient for total internal reflection. Scattered light from the reflector layer is likewise directed to the diffuser layer or experiences a change in angle such that this light is relayed in the light guide layer by means of total internal reflection.

In one embodiment, the region covered by the diffuser layer is larger than that covered by the reflector layer.

In one preferred embodiment, the vehicle window comprises an optical element arranged between the at least one light source and the light guide layer, wherein the optical element comprises a light refracting structure configured to align light emitted by the light source and incoupled into the light guide layer into a more particularly central region of the light guide layer facing away from the edge region of the light guide layer. The optical element comprises for example a light refraction optical unit and/or a light refraction film, which is preferably arranged between the window inner body and the at least one light source and increases the proportion of the light which, proceeding from the at least one light source, is aligned with the center, in particular the central region of the window body arrangement, as viewed in the vehicle width direction. The at least one light source scatters the light preferably at an angle of 120°. In this way, the light is aligned for example with the margin of the window arrangement and the center of the light guide layer. The light toward the margin cannot be used for relaying within the light guide layer, and so this proportion is to be reduced. For this reason, the use of an optical element is preferred in order to align the proportion of the light toward the center. As a result, a higher proportion of the light is scattered into the center of the light guide layer, as viewed in the vehicle width and/or longitudinal direction, such that the luminosity and/or the brightness of the light outcoupled from the light guide layer into the passenger compartment is increased. The optical element can be for example a plastics part arranged on the at least one light source. Alternatively or supplementarily, it can also be a structured film, as already described above. Furthermore, a cover can be arranged on the inner side of the window body arrangement, said cover masking the incoupling element. In this embodiment that satisfies high optical requirements, the light source and optionally the light guide used to incouple the light into the incoupling element can additionally lie behind the cover. The housing can be adhesively bonded to the window body arrangement.

The vehicle window according to the invention can in principle be arranged at any desired point of a motor vehicle, in particular of a vehicle roof, and be designed for various purposes.

It is understood that the embodiments and exemplary embodiments mentioned above and those yet to be explained below are implementable not only individually but also in any desired combination with one another, without departing from the scope of the present invention. It is likewise understood that the embodiments and exemplary embodiments mentioned above and those yet to be explained below equivalently or at least similarly relate to all embodiments of the invention, without being mentioned separately in each case.

Embodiments of the invention are illustrated schematically in the drawings and are explained by way of example below. In the drawings:

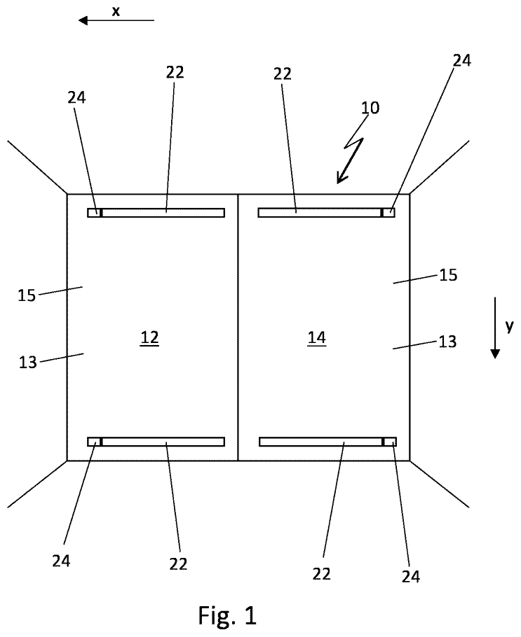

FIG. 1 shows a schematic plan view of a vehicle roof comprising a vehicle window according to the invention;

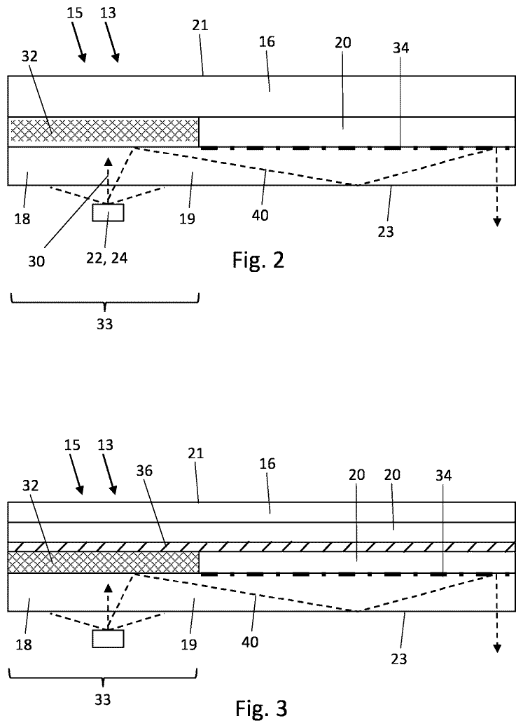

FIG. 2 shows a schematic sectional view through the vehicle window according to a first exemplary embodiment;

FIG. 3 shows a schematic sectional view through the vehicle window according to a second exemplary embodiment;

FIG. 5 shows a schematic view of a vehicle interior in respect of one exemplary embodiment of a vehicle window;

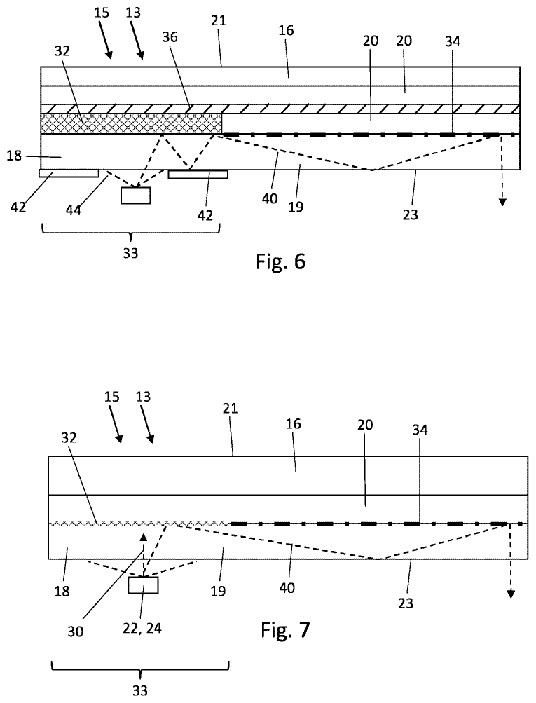

FIG. 6 shows a schematic sectional view through the vehicle window according to a fourth exemplary embodiment; and

FIG. 7 shows a schematic sectional view through the vehicle window according to a fifth exemplary embodiment.

FIG. 1 shows a vehicle roof 10 of a motor vehicle, the rest of which is not illustrated in more specific detail. The vehicle roof 10 is a panoramic roof having an adjustable cover element 12 and a fixed roof element 14, which is fixedly or immovably connected to the vehicle bodywork. Both the cover element 12 and the fixed roof element 14 each comprise a vehicle window 15. In the present case, each vehicle window 15 is in the form of laminated safety glass (LSG) provided with an ambient light functionality. In this regard, the construction of the cover element 12 corresponds to that of the fixed roof element 14. Such a construction of the vehicle window 15 is illustrated in more specific detail in two different exemplary embodiments in FIGS. 2 to 4.

The roof elements 12 and 14 each in the form of a vehicle window 15 each comprise a window body arrangement 13 comprising a window outer body 16 and a window inner body 18. The window outer body 16 is formed from a curved glass sheet manufactured from a colored soda lime glass, for example. It is also conceivable to form the window outer body 16 from a plastics element, for example a polycarbonate element. The window inner body 18 can likewise be manufactured from an inorganic glass, such as a soda lime glass, or a polymer, for example a polycarbonate. Furthermore, in the present context, the window inner body 18 forms a light guide layer 19, in the volume of which incoupled light propagates.

The window outer body 16 and the window inner body 18 are connected to one another via at least one lamination layer or connecting layer 20, which can be formed from a material such as PVB, EVA or TPU. In addition, the connecting layer 20 can be clear or fully transparent or else colored. In the present case, the connecting layer 20 has a thickness of less than one millimeter, but can also have a different thickness. In the case of FIG. 3, a plurality of connecting layers 20 are provided.

The window outer body 16 and the window inner body 18, which in the present case each have a thickness of a few millimeters, form the window body arrangement 13 having an outer side 21 facing the vehicle surroundings, and having an inner side 23 facing the vehicle interior. On the inner side 23, the window body arrangement 13 is provided with respective illumination devices 22 on both sides relative to a vertical roof longitudinal central plane, the ambient light functionality being realized by said illumination devices.

In the present case, the illumination devices 22 each extend in a vehicle longitudinal direction x (see FIG. 1) and are arranged on the respective lateral margins of the cover element 12 and of the fixed roof element 14. The illumination devices 22 are for example arranged directly on the inner side 23 of the window body arrangement 13 and are for example adhesively bonded to the inner side 23 and/or arranged indirectly on, in particular spaced apart from, the inner side 23; see FIGS. 2 and 3. The illumination devices 22 each comprise at least one light source 24 comprising an LED arrangement, in particular an LED bar and/or an LED strip. The at least one light source 24 can be arranged for example at an end face of a light guide (not illustrated in more specific detail), which is formed from a rod or a cord and comprises for example a PMMA material and/or a polycarbonate material.

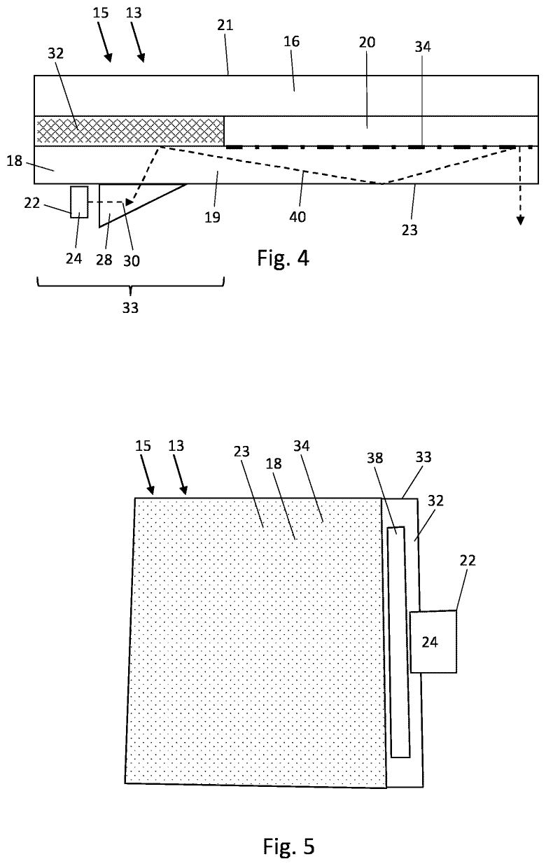

In one exemplary embodiment, the illumination devices 22 can comprise a more particularly barlike incoupling element 28, which for example extends over the length of the respective illumination device 22 and in the present case has a wedge-shaped or triangular cross-section (see FIG. 4). The incoupling elements 28 thus each form a prismatic body. The latter is preferably manufactured from a plastics material in accordance with an extrusion method or an injection molding method, wherein materials used can be in particular PMMA, PC, PA, COC and/or COP, the refractive indices of which are between 1.48 and 1.59. The incoupling element 28 can be fixed to the window body arrangement 13 by way of an adhesive layer, for example. A pressure sensitive adhesive, a liquid optically clear adhesive, EVA, PVB, TPU, an epoxy adhesive or an acrylate adhesive can be used as material for the adhesive layer. An incoupling element 28 of this type makes it possible for the at least one light source 24 also to be arranged laterally, in particular with a main emission direction 30 parallel to the inner side 23 (see FIG. 4).

According to the invention, the window body arrangement 13 and/or the connecting layer 20 at least regionally comprise(s) a diffuser layer 32. The diffuser layer 32 is provided at least in a marginal region 33 and/or an edge region of the vehicle window 15; see FIGS. 2 to 4. The diffuser layer 32 is formed by a hot melt adhesive film and has a diffusivity of at least 90% and/or a light transmission of at most 1%.

Providing the diffuser layer 32 makes it possible for the light source 24 to be arranged on the window body arrangement 13 or the vehicle window 15 in such a way that the main emission direction 30 is aligned in particular substantially perpendicularly or perpendicularly to the inner side 23. The main emission direction 30 preferably extends perpendicularly to the vehicle longitudinal direction x.

A light outcoupling layer 34, in particular having at least one light outcoupling structure, is arranged on a side situated opposite the inner side 23 of the window inner body 18 and/or between the connecting layer 20 and the window inner body 18. In the present case, the light outcoupling layer 34 is printed onto the window inner body 18. Alternatively, the light outcoupling layer 34 can bear or be arranged as a light outcoupling structure on the outer side situated opposite the inner side 23 of the window inner body 18, wherein the light outcoupling layer 34 is preferably embedded in or encompassed by the hot melt adhesive film 20.

According to FIG. 3, the window body arrangement 13 furthermore comprises a light refraction layer 36, which is provided preferably between the window outer body 16 and the window inner body 18, particularly preferably between at least one part of the connecting layer 20 and/or the diffuser layer 32 and the window inner body 18. According to FIG. 3, the light refraction layer 36 is accommodated regionally like a sandwich between two connecting layers 20 and regionally like a sandwich between one of the connecting layers 20 and the diffuser layer 32. The connecting layer 20 connected to the window outer body 16 is continuous in this case. The connecting layer 20 connected to the window inner body 18 is arranged regionally thereon in this case and is replaced by the diffuser layer 32 in the marginal region 33 of the window body arrangement 13. The light refraction layer 36 has a refractive index of at most 1.45.

As is evident from FIG. 5, the vehicle window 15 comprises an optional light shielding element 38 arranged in a region of the light source 24 on the inner side 23 of the window inner body 18. FIG. 4 reveals that a strip of the diffuser layer 32 is provided on the right side. The light shielding element 38 is for example a completely opaque, for example black, shield against stray light and serves as a cover. In the present case, the light outcoupling layer 34 within the surface 23 is a white print, for example.

FIGS. 2 to 4 illustrate an exemplary light path 40 proceeding from the at least one light source 24. Of course, a multiplicity of different light paths 40 run within the light guide layer 19.

FIG. 6 illustrates a fourth embodiment of the invention. This embodiment is based by way of example on the configuration according to FIG. 3, but can also be used in a different configuration offered here, optionally with appropriate adaptation. Opposite the diffuser layer 32, a reflector layer 42 is arranged on the inner side 23 of the window inner body 18 or the light guide layer 19 in the region of the diffuser layer 32. The reflector layer 42 can be embodied preferably as an adhesive layer, in particular as adhesive tape. The reflector layer 42 is embodied in a light-reflecting and/or light-scattering manner with respect to the window inner body 18 or with respect to the light guide layer 19. The reflector layer 42 is arranged such that light reflected out of the window inner body 18 or out of the light guide layer 19 is reflected and/or scattered back into the window inner body 18 or into the light guide layer 19 by said reflector layer. The reflector layer 42 has a cutout 44 in the region of the light source or of a light incoupling element optionally present, such that light from the light source or the light incoupling element is incoupled into the window inner body 18 or into the light guide layer 19.

The embodiment shown in FIG. 7 is based in principle on the exemplary embodiment shown in FIG. 2, wherein the diffuser layer 32 is printed as a more particularly partially delimited printed layer on the connecting layer 20 or the hot melt adhesive layer. The connecting layer 20 preferably extends with constant thickness between the window outer body 16 and the window inner body 18. Thus preferably in a departure from FIG. 2, the connecting layer 20 does not adjoin the diffuser layer 32, but rather is arranged continuously between the window outer body 16 and the window inner body 18.

### LIST OF REFERENCE SIGNS

10 Vehicle roof
12 Cover element
13 Window body arrangement
14 Fixed roof element
15 Vehicle window
16 Window outer body
18 Window inner body
19 Light guide layer
20 Connecting layer
21 Outer side
22 Illumination device
23 Inner side
24 Light source
28 Incoupling element
30 Main emission direction
32 Diffuser layer
33 Marginal region
34 Light outcoupling layer
36 Light refraction layer
38 Light shielding element
40 Light path
42 Reflector layer
44 Cutout
x Vehicle longitudinal direction
y Vehicle width direction

1. A vehicle window, comprising a window body arrangement having a light guide layer, having a window outer body, which has an outer side facing vehicle surroundings, and having a window inner body, which has an inner side facing a vehicle interior, and comprising a light source, the light from which is able to be incoupled into the light guide layer, the window outer body being linked to the window inner body by at least one connecting layer, characterized in that the connecting layer and/or the window body arrangement at least regionally comprise(s) a diffuser layer.

2. The vehicle window as claimed in claim 1, characterized in that the diffuser layer is provided at least in a marginal region and/or an edge region of the vehicle window.

3. The vehicle window as claimed in claim 1, characterized in that the diffuser layer is formed by a hot melt adhesive film, a printed layer and/or a structured film.

4. The vehicle window as claimed in claim 1, characterized in that the diffuser layer has a diffusivity and/or reflectivity of at least 90% and/or a light transmission in the visible spectrum of at most 1%.

5. The vehicle window as claimed in claim 1, characterized in that the light source is arranged directly or indirectly on the inner side of the window inner body.

6. The vehicle window as claimed in claim 1, characterized in that the light source, relative to a main emission direction of the light source, is arranged on the inner side of the window inner body in such a way that light generable by the light source is able to be incoupled substantially perpendicularly into the light guide layer.

7. The vehicle window as claimed in claim 1, characterized in that a light outcoupling layer, in particular having at least one light outcoupling structure, is arranged on a side situated opposite the inner side of the window inner body and/or between the connecting layer and the window inner body.

8. The vehicle window as claimed in claim 1, characterized in that the window body arrangement furthermore comprises a light refraction layer, which is provided between the window outer body and the window inner body.

9. The vehicle window as claimed in claim 8, characterized in that the light refraction layer has a refractive index of at most 1.45.

10. The vehicle window as claimed in claim 1, characterized in that the vehicle window comprises a light shielding element arranged in a region of the light source on the inner side of the window inner body.

11. The vehicle window as claimed in claim 1, characterized in that an incoupling element is arranged on the inner side of the window body arrangement, and incouples light emitted by the light source into the light guide layer.

12. The vehicle window as claimed in claim 11, characterized in that the incoupling element is a material body which is transparent to the light from the light source, said material body being of barlike design and/or having a wedge-shaped or trapezoidal cross-section.

13. The vehicle window as claimed in claim 11, characterized in that the incoupling element is secured to the window body arrangement by way of an adhesive layer.

14. The vehicle window as claimed in claim 11, characterized in that the at least one light source is arranged on a side surface of the incoupling element.

15. The vehicle window as claimed in claim 1, characterized in that the at least one light source is an LED bar.

16. The vehicle window as claimed in claim 1, characterized in that the vehicle window comprises a reflector in a region of the light source, said reflector being aligned in a light-reflecting manner with respect to the light source and being configured to reflect light into the light guide layer.

17. The vehicle window as claimed in claim 1, characterized in that the vehicle window at least regionally comprises a reflector layer in a region of the light source and/or in a region of the incoupling element on that surface of the light guide layer which is assigned to the interior, on the inner side of the window inner body.

18. The vehicle window as claimed in claim 1, comprising an optical element arranged between the light source and the light guide layer, wherein the optical element comprises a light refracting structure configured to align light emitted by the light source and incoupled into the light guide layer into a more particularly central region of the light guide layer facing away from the edge region of the light guide layer.

19. A vehicle roof, comprising at least one vehicle window as claimed in claim 1.

20. The vehicle window as claimed in claim 8, characterized in that the light refraction layer is provided between at least one part of the connecting layer and/or the diffuser layer and the window inner body.
